(19) United States
(12) Patent Application Publication
(10) Pub. No.: US 2017/0108090 A1
(43) Pub. Date: Apr. 20, 2017

(54) PLANETARY GEAR TRAIN OF AUTOMATIC TRANSMISSION FOR VEHICLES

(71) Applicant: Hyundai Motor Company, Seoul (KR)

(72) Inventors: Seongwook JI, Ansan-si (KR); Jae Chang Kook, Hwaseong-si (KR); Hyun Sik Kwon, Seoul (KR); Wonmin Cho, Hwaseong-si (KR); Wookjin Jang, Yongin-si (KR); Seong Wook Hwang, Gunpo-si (KR)

(73) Assignee: Hyundai Motor Company, Seoul (KR)

(21) Appl. No.: 15/178,370

(22) Filed: Jun. 9, 2016

(30) Foreign Application Priority Data
Oct. 15, 2015 (KR) 10-2015-0144300

(51) Int. Cl. F16H 3/66

(52) U.S. Cl. CPC F16H 3/66; F16H 2200/0065; F16H 2200/0069; F16H 2200/0073; F16H 2200/2012; F16H 2200/2046

(57) ABSTRACT

Nine or more forward speeds and at least one reverse speed is achieved by a planetary gear train of an automatic transmission for a vehicle including an input shaft, an output shaft, three planetary gear sets respectively having three rotation elements, and six control elements for selectively interconnecting the rotation elements.

### CROSS-REFERENCE TO RELATED APPLICATION

The present application claims priority to and the benefit of Korean Patent Application No. 10-2015-0144300 filed on Oct. 15, 2015, the entire contents of which is incorporated herein for all purposes by this reference.

### BACKGROUND OF THE INVENTION

Field of the Invention

The present invention relates to an automatic transmission for a vehicle. More particularly, the present invention relates to a planetary gear train of an automatic transmission of a vehicle that can improve power delivery performance and reduce fuel consumption by achieving at least nine or more forward speed stages using a minimum number of constituent elements.

Description of Related Art

In recent years, a rise in oil price has caused unlimited competition for enhancing fuel efficiency.

As a result, researches into reduction of weight and enhancement of fuel efficiency through down-sizing are being conducted in the case of an engine, and researches for simultaneously securing operability and fuel efficiency competitiveness through multistages are being conducted in the case of an automatic transmission.

However, in the automatic transmission, as a number of transmission stages increases, the number of internal components increases, and as a result, mountability, cost, weight, transmission efficiency, and the like may still deteriorate.

Accordingly, development of a planetary gear train which may bring about maximum efficiency with a small number of components may be important in order to increase a fuel efficiency enhancement effect through the multistages.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a planetary gear train of an automatic transmission for a vehicle having advantages of improving power delivery performance and fuel efficiency by achieving at least nine or more forward speed stages using a driving point positioned at a low engine speed.

A planetary gear train of an automatic transmission for a vehicle according to an exemplary embodiment of the present invention may include: an input shaft receiving torque of an engine; an output shaft outputting changed torque; a first planetary gear set having first, second, and third rotational elements; a second planetary gear set having fourth, fifth, and sixth rotational elements; a third planetary gear set having seventh, eighth, and ninth rotational elements; a first rotation shaft including the first rotational element and selectively connectable to a transmission housing; a second rotation shaft including the second rotational element and directly connected to the input shaft; a third rotation shaft including the third rotational element and the seventh rotational element; a fourth rotation shaft including the fourth rotational element and selectively connectable to the first rotation shaft and the second rotation shaft; a fifth rotation shaft including the fifth rotational element and selectively connectable to the third rotation shaft; a sixth rotation shaft including the sixth rotational element and the eighth rotational element and directly connected to the output shaft; and a seventh rotation shaft including the ninth rotational element, and selectively connectable to the fifth rotation shaft or selectively connectable to the transmission housing.

The first planetary gear set may be a single-pinion planetary gear set, in which the first rotation element may be a first sun gear, the second rotation element may be a first planet carrier, and the third rotation element may be a first ring gear, the second planetary gear set may be a single-pinion planetary gear set, in which the fourth rotation element may be a second sun gear, the fifth rotation element may be a second planet carrier, and the sixth rotation element may be a second ring gear, the third planetary gear set may be a single-pinion planetary gear set, in which the seventh rotation element may be a third sun gear, the eighth rotation element may be a third planet carrier, and the ninth rotation element may be a third ring gear.

The planetary gear train may further include: a first clutch that selectively connects the second rotation shaft and the fourth rotation shaft; a second clutch that selectively connects the first rotation shaft and the fourth rotation shaft; a third clutch that selectively connects the third rotation shaft and the fifth rotation shaft; a fourth clutch that selectively connects the fifth rotation shaft and the seventh rotation shaft; a first brake that selectively connects the first rotation shaft and the transmission housing; and a second brake that selectively connects the seventh rotation shaft and the transmission housing.

A first forward speed stage may be achieved by operation of the first and third clutches and the second brake, a second forward speed stage may be achieved by operation of the second and third clutches and the second brake, a third forward speed stage may be achieved by operation of the first and second clutches and the second brake, a fourth forward speed stage may be achieved by operation of the second clutch and the first and second brakes, a fifth forward speed stage may be achieved by operation of the second and fourth clutches and the second brake, a sixth forward speed stage may be achieved by operation of the first, second, and fourth clutches, a seventh forward speed stage may be achieved by operation of the first and fourth clutches and the first brake, an eighth forward speed stage may be achieved by operation of the first and third clutches and the first brake, a ninth forward speed stage may be achieved by operation of the second and third clutch and the first brake, a reverse speed stage may be achieved by operation of the first and fourth clutches and the second brake.

A first forward speed stage may be achieved by operation of the first and third clutches and the second brake, a second forward speed stage may be achieved by operation of the second and third clutches and the second brake, a third forward speed stage may be achieved by operation of the first and second clutches and the second brake, a fourth forward speed stage may be achieved by operation of the second clutch and the first and second brakes, a fifth forward speed stage may be achieved by operation of the second and fourth clutches and the second brake, a sixth forward speed stage may be achieved by operation of the second and fourth clutches and the first brake, a seventh forward speed stage may be achieved by operation of the first, second, and fourth clutches, an eighth forward speed stage may be achieved by operation of the first and fourth clutches and the first brake, a ninth forward speed stage may be achieved by operation of the first and third clutch and the first brake, a tenth forward speed stage may be achieved by operation of the second and third clutches and the first brake, a reverse speed stage may be achieved by operation of the first and fourth clutches and the second brake.

A first forward speed stage may be achieved by operation of the first and third clutches and the second brake, a second forward speed stage may be achieved by operation of the second and third clutches and the second brake, a third forward speed stage may be achieved by operation of the first and second clutches and the second brake, a fourth forward speed stage may be achieved by operation of the second clutches and the first and second brakes, a fifth forward speed stage may be achieved by operation of the second and fourth clutches and the second brake, a sixth forward speed stage may be achieved by operation of the second and fourth clutches and the first brake, a seventh forward speed stage may be achieved by operation of the first, second, and fourth clutches, an eighth forward speed stage may be achieved by operation of the first and fourth clutches and the first brake, a ninth forward speed stage may be achieved by operation of the third and fourth clutches and the first brake, a tenth forward speed stage may be achieved by operation of the first and third clutches and the first brake, an eleventh forward speed stage may be achieved by operation of the second and third clutches and the first brake, a reverse speed stage may be achieved by operation of the first and fourth clutches and the second brake.

An exemplary embodiment of the present invention may achieve at least nine or more forward speed stages and one reverse speed stage by combining three planetary gear sets with six friction elements. Therefore, power delivery performance and fuel efficiency may be improved.

Since a speed stage suitable for an engine speed can be achieved due to multiple speed stages, silent driving may be improved.

Since engine driving efficiency can be achieved due to multiple speed stages, power delivery performance and fuel efficiency may be improved.

Further, effects that can be obtained or expected from exemplary embodiments of the present invention are directly or suggestively described in the following detailed description. That is, various effects expected from exemplary embodiments of the present invention will be described in the following detailed description.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a configuration diagram of a planetary gear train according to a first exemplary embodiment of the present invention.

FIG. 2 is a table representing operations at respective gear shift stages implemented by respective friction elements when nine forward speed stages and one reverse speed stage is achieved by the planetary gear train according to the exemplary embodiment of the present invention.

FIG. 3 is a table representing operations at respective gear shift stages implemented by respective friction elements when ten forward speed stages and one reverse speed stage is achieved by the planetary gear train according to the exemplary embodiment of the present invention.

FIG. 4 is a table representing operations at respective gear shift stages implemented by respective friction elements when eleven forward speed stages and one reverse speed stage is achieved by the planetary gear train according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The present invention will be described more fully hereinafter with reference to the accompanying drawings, in which exemplary embodiments of the invention are illustrated. As those skilled in the art would realize, the described embodiments may be modified in various different ways, all without departing from the spirit or scope of the present invention.

Components unrelated to the description will be omitted in order to obviously describe the present invention, and like reference numerals will be used to describe like components throughout the present specification.

In the following description, dividing names of components into first, second, and the like is to divide the names because the names of the components are the same as each other, and an order thereof is not particularly limited.

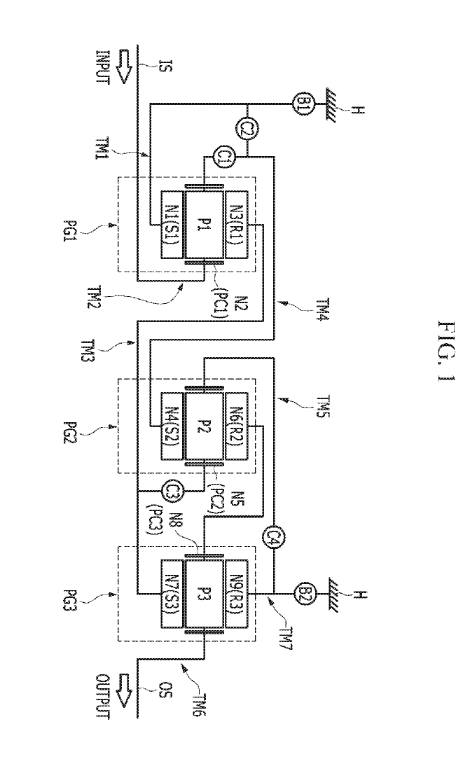

FIG. 1 is a configuration diagram of a planetary gear train according to a first exemplary embodiment of the present invention.

Referring to FIG. 1, a planetary gear train according to an exemplary embodiment of the present invention includes first, second, and third planetary gear sets PG1, PG2, and PG3 disposed on the same axis, an input shaft IS, an output shaft OS, seven rotation shafts TM1 to TM7 including at least one of rotation elements of the first, second, and third planetary gear sets PG1, PG2, and PG3, six friction elements C1 to C4, B1, and B2, and a transmission housing H.

As a result, torque input from the input shaft IS is changed by cooperation of the first, second, and third planetary gear sets PG1, PG2, and PG3, and the changed torque is output through the output shaft OS.

The planetary gear sets PG1, PG2, and PG3 are disposed sequentially from an engine side.

The input shaft IS is an input member, and power from a crankshaft of an engine is torque-converted through a torque converter to be input into the input shaft IS.

The output shaft OS is an output member, is disposed in parallel with the input shaft IS, and transmits driving torque to a driving wheel through a differential apparatus.

The first planetary gear set PG1 as a single-pinion planetary gear set includes a first sun gear S1 which is a first rotation element N1, a first planetary carrier PC1 which is a second rotation element N2 that supports a first pinion P1 which outer-engages with the first sun gear S1 which is the first rotation element N1, and a first ring gear R1 which is a third rotation element N3 which inner-engages with the first pinion P1 as rotation elements.

The second planetary gear set PG2 as a single-pinion planetary gear set includes a second sun gear S2 which is a fourth rotation element N4, a second planet carrier PC2 which is a fifth rotation element N5 that supports a second pinion P2 which outer-engages with the second sun gear S2 which is the fourth rotation element N4, and a second ring gear R2 which is a sixth rotation element N6 which inner-engages with the second pinion P2 as rotation elements.

The third planetary gear set PG3 as a single-pinion planetary gear set includes a third sun gear S3 which is a seventh rotation element N7, a third planet carrier PC3 which is an eighth rotation element N8 that supports a third pinion P3 which outer-engages with the third sun gear S3 which is the seventh rotation element N7, and a third ring gear R3 which is a ninth rotation element N9 which inner-engages with the third pinion P3 as the rotation elements.

In the first, second, and third planetary gear set PG1, PG2, and PG3, the third rotational element N3 is directly connected to the seventh rotational element N7, and the sixth rotational element N6 is directly connected to the eighth rotational element N8 so as to be operated with a total of seven rotation shafts TM1 to TM7.

Configurations of the seven rotation shafts TM1 to TM7 will be described below.

The first rotation shaft TM1 includes the first rotational element N1 (the first sun gear S1) and is selectively connectable to the transmission housing H.

The second rotation shaft TM2 includes the second rotational element N2 (the first planet carrier PC1), and is directly connected to the input shaft IS so as to continuously be operated as an input element.

The third rotation shaft TM3 includes the third rotational element N3 (the first ring gear R1) and the seventh rotational element N7 (the third sun gear S3).

The fourth rotation shaft TM4 includes the fourth rotational element N4 (the second sun gear S2), and is selectively connectable to the first rotation shaft TM1 and the second rotation shaft TM2.

The fifth rotation shaft TM5 includes the fifth rotational element N5 (the second planet carrier PC2), and is selectively connectable to the third rotation shaft TM3

The sixth rotation shaft TM6 includes the sixth rotational element N6 (the third ring gear R2) and the eighth rotational element N8 (the third planet carrier PC3), and is directly connected to the output shaft OS so as to continuously be operated as an output element.

The seventh rotation shaft TM7 includes the ninth rotational element N9 (the third ring gear R3), and is selectively connectable to the fifth rotation shaft TM5 or selectively connectable to the transmission housing H.

In addition, among the rotation shafts TM1 to TM7, four clutches C1, C2, C3, and C4 which are friction elements are disposed at connection portions where the rotation shafts are connected to each other.

Further, among the rotation shafts TM1 to TM7, two brakes B1 and B2 which are friction elements are disposed at connection portions between any one rotation shaft and the transmission housing H.

The six friction elements C1 to C4. B1, and B2 will now be described in further detail.

The first clutch C1 is interposed between the second rotation shaft TM2 and the fourth rotation shaft TM4, and selectively connects the second rotation shaft TM2 and the fourth rotation shaft TM4.

The second clutch C2 is interposed between the first rotation shaft TM1 and the fourth rotation shaft TM4, and selectively connects the first rotation shaft TM1 and the fourth rotation shaft TM4.

The third clutch C3 is interposed between the third rotation shaft TM3 and the fifth rotation shaft TM5, and selectively connects the third rotation shaft TM3 and the fifth rotation shaft TM5.

The fourth clutch C4 is interposed between the fifth rotation shaft TM5 and the seventh rotation shaft TM7, and selectively connects the fifth rotation shaft TM5 and the seventh rotation shaft TM7.

The first brake B1 is interposed between the first rotation shaft TM1 and the transmission housing H, and selective causes the first rotation shaft TM1 to be operated as a fixed element.

The second brake B2 is interposed between the seventh rotation shaft TM7 and the transmission housing H, and selective causes the seventh rotation shaft TM7 to be operated as a fixed element.

The friction elements including the first, second, third, and fourth clutches C1, C2, C3, and C4 and the first and second brakes B1 and B2 may be multi-plates friction elements of a wet type that are operated by hydraulic pressure.

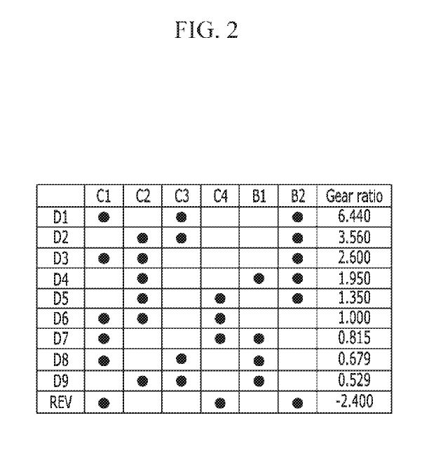

FIG. 2 is a table representing operations at respective gear shift stages implemented by respective friction elements when nine forward speed stages and one reverse speed stage is achieved by the planetary gear train according to the exemplary embodiment of the present invention.

As shown in FIG. 2, three friction elements are operated at each speed stage in the planetary gear train according to the exemplary embodiment of the present invention.

The first and third clutches C1 and C3 and the second brake B2 are operated at a first forward speed stage D1. In a state that the second rotation shaft TM2 is connected to fourth rotation shaft TM4, and the third rotation shaft TM3 is connected to the fifth rotation shaft TM5, rotation speed of the input shaft IS is input to the second rotation shaft TM2. The seventh rotation shaft TM7 is operated as the fixed element, and the first forward speed stage is achieved.

The second and third clutches C2 and C3 and the second brake B2 are operated at a second speed stage D2. In a state that the first rotation shaft TM1 is connected to the fourth rotation shaft TM4, and the third rotation shaft TM3 is connected to the fifth rotation shaft TM5, rotation speed of the input shaft IS is input to the second rotation shaft TM2. The seventh rotation shaft TM7 is operated as the fixed element, and the second forward speed stage is achieved.

The first and second clutches C1 and C2 and the second brake B2 are operated at a third forward speed stage D3. In a state that the second rotation shaft TM2 is connected to the fourth rotation shaft TM4, and the first rotation shaft TM1 is connected to the fourth rotation shaft TM4, rotation speed of the input shaft IS is input to the second rotation shaft TM2. The seventh rotation shaft TM7 is operated as the fixed element, and the third forward speed stage is achieved.

The second clutch C2 and the first and second brakes B1 and B2 are operated at a fourth forward speed stage D4. In a state that the fourth rotation shaft TM4 is connected to the fourth rotation shaft TM4, rotation speed of the input shaft IS is input to the second rotation shaft TM2. The first rotation shaft TM1 and the seventh rotation shaft TM7 are operated as the fixed elements, and the fourth forward speed stage is achieved.

The second and fourth clutches C2 and C4 and the second brake B2 are operated at a fifth forward speed stage D5. In a state that the first rotation shaft TM1 is connected to the fourth rotation shaft TM4, and the fifth rotation shaft TM5 is connected to the seventh rotation shaft TM7, rotation speed of the input shaft IS is input to the second rotation shaft TM2. The seventh rotation shaft TM7 is operated as the fixed element, and the fifth forward speed stage is achieved.

The first, second, and fourth clutches C1, C2, and C4 are operated at a sixth forward speed stage D6. In a state that the second rotation shaft TM2 is connected to the fourth rotation shaft TM4, the first rotation shaft TM1 is connected to the fourth rotation shaft TM4, and the fifth rotation shaft TM5 is connected to the seventh rotation shaft TM7, such that all of the first, second, third, and fourth planetary gear sets PG1, PG2, PG3, and PG4 are directly connected, and as a result, the sixth forward speed stage, which outputs the inputted power as it is, is achieved.

The first and fourth clutches C1 and C4 and the first brake B1 are operated at a seventh forward speed stage D7. In a state that the second rotation shaft TM2 is connected to the fourth rotation shaft TM4, and the fifth rotation shaft TM5 is connected to the seventh rotation shaft TM7, rotation speed of the input shaft IS is input to the second rotation shaft TM2. The first rotation shaft TM1 is operated as the fixed element, and the seventh forward speed stage is achieved.

The first and third clutches C1 and C3 and the first brake B1 are operated at an eighth forward speed stage D8. In a state that the second rotation shaft TM2 is connected to the fourth rotation shaft TM4, and the third rotation shaft TM3 is connected to the fifth rotation shaft TM5, rotation speed of the input shaft IS is input to the second rotation shaft TM2. The first rotation shaft TM1 is operated as the fixed element, and the eighth forward speed stage is achieved.

The second and third clutches C2 and C3 and the first brake B1 and the first brake B1 are operated at a ninth forward speed stage D9. In a state that the first rotation shaft TM1 is connected to the fourth rotation shaft TM4, and the third rotation shaft TM3 is connected to the fifth rotation shaft TM5, rotation speed of the input shaft IS is input to the second rotation shaft TM2. The first rotation shaft TM1 is operated as the fixed element, and the ninth forward speed stage is achieved.

The first and fourth clutches C1 and C4 and the second brake B2 are operated at a reverse speed stage REV 1. In a state that the second rotation shaft TM2 is connected to the fourth rotation shaft TM4, and the fifth rotation shaft TM5 is connected to the seventh rotation shaft TM7, rotation speed of the input shaft IS is input to the second rotation shaft TM2. The seventh rotation shaft TM1 is operated as the fixed element, and the reverse speed stage is achieved.

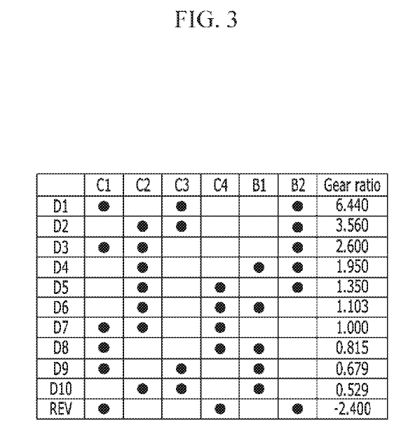

FIG. 3 is a table representing operations at respective gear shift stages implemented by respective friction elements when ten forward speed stages and one reverse speed stage is achieved by the planetary gear train according to the exemplary embodiment of the present invention.

As shown in FIG. 3, three friction elements are operated at each speed stage even while shifting ten forward speed stages and one reverse speed stage. Shifting processes in the exemplary embodiment of the present invention will be described in further detail.

The first and third clutches C1 and C3 and the second brake B2 are operated at a first forward speed stage D1. In a state that the second rotation shaft TM2 is connected to the fourth rotation shaft TM4, and the third rotation shaft TM3 is connected to the fifth rotation shaft TM5, rotation speed of the input shaft IS is input to the second rotation shaft TM2. The seventh rotation shaft TM7 is operated as the fixed element, and the first forward speed stage is achieved.

The second and third clutches C2 and C3 and the second brake B2 are operated at a second speed stage D2. In a state that the first rotation shaft TM1 is connected to the fourth rotation shaft TM4, and the third rotation shaft TM3 is connected to the fifth rotation shaft TM5, rotation speed of the input shaft IS is input to the second rotation shaft TM2. The seventh rotation shaft TM7 is operated as the fixed element, and the second forward speed stage is achieved.

The first and second clutches C1 and C2 and the second brake B2 are operated at a third forward speed stage D3. In a state that the second rotation shaft TM2 is connected to the fourth rotation shaft TM4, and the first rotation shaft TM1 is connected to the fourth rotation shaft TM4, rotation speed of the input shaft IS is input to the second rotation shaft TM2. The seventh rotation shaft TM7 is operated as the fixed element, and the third forward speed stage is achieved.

The second clutch C2 and the first and second brakes B1 and B2 are operated at a fourth forward speed stage D4. In a state that the fourth rotation shaft TM4 is connected to the fourth rotation shaft TM4, rotation speed of the input shaft IS is input to the second rotation shaft TM2. The first rotation shaft TM1 and the seventh rotation shaft TM7 are operated as the fixed elements, and the fourth forward speed stage is achieved.

The second and fourth clutches C2 and C4 and the second brake B2 are operated at a fifth forward speed stage D5. In a state that the first rotation shaft TM1 is connected to the fourth rotation shaft TM4, and the fifth rotation shaft TM5 is connected to the seventh rotation shaft TM7, rotation speed of the input shaft IS is input to the second rotation shaft TM2. The seventh rotation shaft TM7 is operated as the fixed element and the fifth forward speed stage is achieved.

The second and fourth clutches C2 and C4 and the first brake B1 are operated at a sixth forward speed stage D6. In a state that the first rotation shaft TM1 is connected to the fourth rotation shaft TM4, and the fifth rotation shaft TM5 is connected to the seventh rotation shaft TM7, rotation speed of the input shaft IS is input to the second rotation shaft TM2. The first rotation shaft TM1 is operated as the fixed element, and the sixth forward speed stage is achieved.

The first, second, and fourth clutches C1, C2, and C4 and the first brake B1 are operated at a seventh forward speed stage D7. In a state that the second rotation shaft TM2 is connected to the fourth rotation shaft TM4, the first rotation shaft TM1 is connected to the fourth rotation shaft TM4, and the fifth rotation shaft TM5 is connected to the seventh rotation shaft TM7, such that all of the first, second, third, and fourth planetary gear sets PG1, PG2, PG3, and PG4 are directly connected, and as a result, the seventh forward speed stage, which outputs the inputted power as it is, is achieved.

The first and fourth clutches C1 and C4 and the first brake B1 are operated at an eighth forward speed stage D8. In a state that the second rotation shaft TM2 is connected to the fourth rotation shaft TM4, and the fifth rotation shaft TM5 is connected to the seventh rotation shaft TM7, rotation speed of the input shaft IS is input to the second rotation shaft TM2. The first rotation shaft TM1 is operated as the fixed element, and the eighth forward speed stage is achieved.

The first and third clutches C1 and C3 and the first brake B1 and the first brake B1 are operated at a ninth forward speed stage D9. In a state that the second rotation shaft TM2 is connected to the fourth rotation shaft TM4, and the third rotation shaft TM3 is connected to the fifth rotation shaft TM5, rotation speed of the input shaft IS is input to the second rotation shaft TM2. The first rotation shaft TM1 is operated as the fixed element, and the ninth forward speed stage is achieved.

The second and third clutches C2 and C3 and the first brake B1 and the first brake B1 are operated at a tenth forward speed stage D10. In a state that the first rotation shaft TM1 is connected to the fourth rotation shaft TM4, and the third rotation shaft TM3 is connected to the fifth rotation shaft TM5, rotation speed of the input shaft IS is input to the second rotation shaft TM2. The first rotation shaft TM1 is operated as the fixed element, and the tenth forward speed stage is achieved.

The first and fourth clutches C1 and C4 and the second brake B2 are operated at a reverse speed stage REV. In a state that the second rotation shaft TM2 is connected to the fourth rotation shaft TM4, and the fifth rotation shaft TM5 is connected to the seventh rotation shaft TM7, rotation speed of the input shaft IS is input to the second rotation shaft TM2. The seventh rotation shaft TM1 is operated as the fixed element, and the reverse speed stage is achieved.

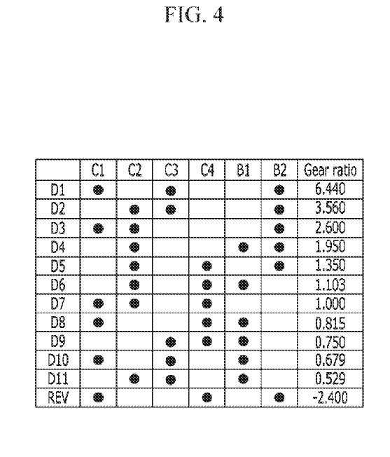

FIG. 4 is a table representing operations at respective gear shift stages implemented by respective friction elements when eleven forward speed stages and one reverse speed stage is achieved by the planetary gear train according to the exemplary embodiment of the present invention.

As shown in FIG. 3, three friction elements are operated at each speed stage even while shifting eleven forward speed stages and one reverse speed stage. Shifting processes in the exemplary embodiment of the present invention will be described in further detail.

The first and third clutches C1 and C3 and the second brake B2 are operated at a first forward speed stage D1. In a state that the second rotation shaft TM2 is connected to the fourth rotation shaft TM4, and the third rotation shaft TM3 is connected to the fifth rotation shaft TM5, rotation speed of the input shaft IS is input to the second rotation shaft TM2. The seventh rotation shaft TM7 is operated as the fixed element, and the first forward speed stage is achieved.

The second and third clutches C2 and C3 and the second brake B2 are operated at a second speed stage D2. In a state that the first rotation shaft TM1 is connected to the fourth rotation shaft TM4, and the third rotation shaft TM3 is connected to the fifth rotation shaft TM5, rotation speed of the input shaft IS is input to the second rotation shaft TM2. The seventh rotation shaft TM7 is operated as the fixed element, and the second forward speed stage is achieved.

The first and second clutches C1 and C2 and the second brake B2 are operated at a third forward speed stage D3. In a state that the second rotation shaft TM2 is connected to the fourth rotation shaft TM4, and the first rotation shaft TM1 is connected to the fourth rotation shaft TM4, rotation speed of the input shaft IS is input to the second rotation shaft TM2. The seventh rotation shaft TM7 is operated as the fixed element, and the third forward speed stage is achieved.

The second clutch C2 and the first and second brakes B1 and B2 are operated at a fourth forward speed stage D4. In a state that the fourth rotation shaft TM4 is connected to the fourth rotation shaft TM4, rotation speed of the input shaft IS is input to the second rotation shaft TM2. The first rotation shaft TM1 and the seventh rotation shaft TM7 are operated as the fixed elements, and the fourth forward speed stage is achieved.

The second and fourth clutches C2 and C4 and the second brake B2 are operated at a fifth forward speed stage D5. In a state that the first rotation shaft TM1 is connected to the fourth rotation shaft TM4, and the fifth rotation shaft TM5 is connected to the seventh rotation shaft TM7, rotation speed of the input shaft IS is input to the second rotation shaft TM2. The seventh rotation shaft TM7 is operated as the fixed element, and the fifth forward speed stage is achieved.

The second and fourth clutches C2 and C4 and the first brake B1 are operated at a sixth forward speed stage D6. In a state that the first rotation shaft TM1 is connected to the fourth rotation shaft TM4, and the fifth rotation shaft TM5 is connected to the seventh rotation shaft TM7, rotation speed of the input shaft IS is input to the second rotation shaft TM2. The first rotation shaft TM1 is operated as the fixed element, and the sixth forward speed stage is achieved.

The first, second, and fourth clutches C1, C2, and C4 and the first brake B1 are operated at a seventh forward speed stage D7. In a state that the second rotation shaft TM2 is connected to the fourth rotation shaft TM4, and the first rotation shaft TM1 is connected to the fourth rotation shaft TM4, the fifth rotation shaft TM5 is connected to the seventh rotation shaft TM7, such that all of the first, second, third, and fourth planetary gear sets PG1, PG2, PG3, and PG4 are directly connected, and as a result, the seventh forward speed stage, which outputs the inputted power as it is, is achieved.

The first and fourth clutches C1 and C4 and the first brake B1 are operated at an eighth forward speed stage D8. In a state that the second rotation shaft TM2 is connected to the fourth rotation shaft TM4, and the fifth rotation shaft TM5 is connected to the seventh rotation shaft TM7, rotation speed of the input shaft IS is input to the second rotation shaft TM2. The first rotation shaft TM1 is operated as the fixed element, and the eighth forward speed stage is achieved.

The third and fourth clutches C3 and C4 and the first brake B1 and the first brake B1 are operated at a ninth forward speed stage D9. In a state that the third rotation shaft TM3 is connected to the fifth rotation shaft TM5, and the fifth rotation shaft TM5 is connected to the seventh rotation shaft TM7, rotation speed of the input shaft IS is input to the second rotation shaft TM2. The first rotation shaft TM1 is operated as the fixed element, and the ninth forward speed stage is achieved.

The first and third clutches C1 and C3 and the first brake B1 and the first brake B1 are operated at a tenth forward speed stage D10. In a state that the second rotation shaft TM2 is connected to the fourth rotation shaft TM4, and the third rotation shaft TM3 is connected to the fifth rotation shaft TM5, rotation speed of the input shaft IS is input to the second rotation shaft TM2. The first rotation shaft TM1 is operated as the fixed element, and the tenth forward speed stage is achieved.

The second and third clutches C2 and C3 and the first brake B1 and the first brake B are operated at a eleventh forward speed stage D10. In a state that the first rotation shaft TM1 is connected to the fourth rotation shaft TM4, and the third rotation shaft TM3 is connected to the fifth rotation shaft TM5, rotation speed of the input shaft IS is input to the second rotation shaft TM2. The first rotation shaft TM1 is operated as the fixed element, and the eleventh forward speed stage is achieved.

The first and fourth clutches C1 and C4 and the second brake B2 are operated at a reverse speed stage REV 1. In a state that the second rotation shaft TM2 is connected to the fourth rotation shaft TM4, and the fifth rotation shaft TM5 is connected to the seventh rotation shaft TM7, rotation speed of the input shaft IS is input to the second rotation shaft TM2. The seventh rotation shaft TM is operated as the fixed element, and the reverse speed stage is achieved.

The planetary gear train according to an exemplary embodiment of the present invention may achieve at least nine forward speed stages to eleven forward speed stages, and one reverse speed stage by control of four planetary gear sets PG1, PG2, PG3, and PG4 with four clutches C1, C2, C3, and C4, and two brakes B1 and B2.

Since a speed stage suitable for an engine speed can be achieved due to multiple speed stages, silent driving may be improved.

Since engine driving efficiency can be achieved due to multiple speed stages, power delivery performance and fuel efficiency may be improved.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A planetary gear train of an automatic transmission for a vehicle, comprising:
an input shaft configured for receiving torque of an engine;
an output shaft configured for outputting changed torque;
a first planetary gear set having first, second, and third rotation elements;
a second planetary gear set having fourth, fifth, and sixth rotation elements;
a third planetary gear set having seventh, eighth, and ninth rotation elements;
a first rotation shaft including the first rotation element and selectively connectable to a transmission housing;
a second rotation shaft including the second rotation element and directly connected to the input shaft;
a third rotation shaft including the third rotation element and the seventh rotation element;
a fourth rotation shaft including the fourth rotation element and selectively connectable to the first rotation shaft and the second rotation shaft;
a fifth rotation shaft including the fifth rotation element and selectively connectable to the third rotation shaft;
a sixth rotation shaft including the sixth rotation element and the eighth rotation element and directly connected to the output shaft; and
a seventh rotation shaft including the ninth rotation element, and selectively connectable to the fifth rotation shaft or selectively connectable to the transmission housing.

2. The planetary gear train of claim 1, wherein
the first planetary gear set is a single-pinion planetary gear set, in which the first rotation element is a first sun gear, the second rotation element is a first planet carrier, and the third rotation element is a first ring gear,
the second planetary gear set is a single-pinion planetary gear set, in which the fourth rotation element is a second sun gear, the fifth rotation element is a second planet carrier, and the sixth rotation element is a second ring gear, and
the third planetary gear set is a single-pinion planetary gear set, in which the seventh rotation element is a third sun gear, the eighth rotation element is a third planet carrier, and the ninth rotation element is a third ring gear.

3. The planetary gear train of claim 1, further comprising:
a first clutch that selectively connects the second rotation shaft and the fourth rotation shaft:
a second clutch that selectively connects the first rotation shaft and the fourth rotation shaft;
a third clutch that selectively connects the third rotation shaft and the fifth rotation shaft;
a fourth clutch that selectively connects the fifth rotation shaft and the seventh rotation shaft;
a first brake that selectively connects the first rotation shaft and the transmission housing; and
a second brake that selectively connects the seventh rotation shaft and the transmission housing.

4. The planetary gear train of claim 3, wherein
a first forward speed stage is achieved by operation of the first and third clutches and the second brake,
a second forward speed stage is achieved by operation of the second and third clutches and the second brake,
a third forward speed stage is achieved by operation of the first clutch and second clutch and the second brake,
a fourth forward speed stage is achieved by operation of the second clutch and the first and second brakes,
a fifth forward speed stage is achieved by operation of the second and fourth clutches and the second brake,
a sixth forward speed stage is achieved by operation of the first, second, and fourth clutches,
a seventh forward speed stage is achieved by operation of the first and fourth clutches and the first brake,
an eighth forward speed stage is achieved by operation of the first and third clutches and the first brake,
a ninth forward speed stage is achieved by operation of the second and third clutch and the first brake,
a reverse speed stage is achieved by operation of the first and fourth clutches and the second brake.

5. The planetary gear train of claim 3, wherein
a first forward speed stage is achieved by operation of the first and third clutches and the second brake,
a second forward speed stage is achieved by operation of the second and third clutches and the second brake,
a third forward speed stage is achieved by operation of the first clutch and second clutch and the second brake,
a fourth forward speed stage is achieved by operation of the second clutch and the first and second brakes,
a fifth forward speed stage is achieved by operation of the second and fourth clutches and the second brake,
a sixth forward speed stage is achieved by operation of the second and fourth clutches and the first brake,
a seventh forward speed stage is achieved by operation of the first, second, and fourth clutches,
an eighth forward speed stage is achieved by operation of the first and fourth clutches and the first brake,
a ninth forward speed stage is achieved by operation of the first and third clutch and the first brake,
a tenth forward speed stage is achieved by operation of the second and third clutches and the first brake,
a reverse speed stage is achieved by operation of the first and fourth clutches and the second brake.

6. The planetary gear train of claim 3, wherein
a first forward speed stage is achieved by operation of the first and third clutches and the second brake,
a second forward speed stage is achieved by operation of the second and third clutches and the second brake,
a third forward speed stage is achieved by operation of the first clutch and second clutch and the second brake,
a fourth forward speed stage is achieved by operation of the second clutches and the first and second brakes,
a fifth forward speed stage is achieved by operation of the second and fourth clutches and the second brake,
a sixth forward speed stage is achieved by operation of the second and fourth clutches and the first brake,
a seventh forward speed stage is achieved by operation of the first, second, and fourth clutches,
an eighth forward speed stage is achieved by operation of the first and fourth clutches and the first brake,
a ninth forward speed stage is achieved by operation of the third and fourth clutches and the first brake,
a tenth forward speed stage is achieved by operation of the first and third clutches and the first brake,
an eleventh forward speed stage is achieved by operation of the second and third clutches and the first brake,
a reverse speed stage is achieved by operation of the first and fourth clutches and the second brake.

7. A planetary gear train of an automatic transmission for a vehicle, comprising:
an input shaft configured for receiving torque of an engine;
an output shaft configured for outputting changed torque;
a first planetary gear set having first, second, and third rotation elements;
a second planetary gear set having fourth, fifth, and sixth rotation elements;
a third planetary gear set having seventh, eighth, and ninth rotation elements;
a first rotation shaft including the first rotation element and selectively connectable to a transmission housing;
a second rotation shaft including the second rotation element and directly connected to the input shaft;
a third rotation shaft including the third rotation element and the seventh rotation element;
a fourth rotation shaft including the fourth rotation element and selectively connectable to the first rotation shaft and the second rotation shaft;
a fifth rotation shaft including the fifth rotation element and selectively connectable to the third rotation shaft;
a sixth rotation shaft including the sixth rotation element and the eighth rotation element and directly connected to the output shaft;
a seventh rotation shaft including the ninth rotation element, and selectively connectable to the fifth rotation shaft or selectively connectable to the transmission housing;
a first clutch that selectively connects the second rotation shaft and the fourth rotation shaft;
a second clutch that selectively connects the first rotation shaft and the fourth rotation shaft;
a third clutch that selectively connects the third rotation shaft and the fifth rotation shaft;
a fourth clutch that selectively connects the fifth rotation shaft and the seventh rotation shaft;
a first brake that selectively connects the first rotation shaft and the transmission housing; and
a second brake that selectively connects the seventh rotation shaft and the transmission housing.

8. The planetary gear train of claim 7, wherein
the first planetary gear set is a single-pinion planetary gear set, in which the first rotation element is a first sun gear, the second rotation element is a first planet carrier, and the third rotation element is a first ring gear,
the second planetary gear set is a single-pinion planetary gear set, in which the fourth rotation element is a second sun gear, the fifth rotation element is a second planet carrier, and the sixth rotation element is a second ring gear, and
the third planetary gear set is a single-pinion planetary gear set, in which the seventh rotation element is a third sun gear, the eighth rotation element is a third planet carrier, and the ninth rotation element is a third ring gear.

9. The planetary gear train of claim 7, wherein
a first forward speed stage is achieved by operation of the first and third clutches and the second brake,
a second forward speed stage is achieved by operation of the second and third clutches and the second brake,
a third forward speed stage is achieved by operation of the first clutch and second clutch and the second brake,
a fourth forward speed stage is achieved by operation of the second clutch and the first and second brakes,
a fifth forward speed stage is achieved by operation of the second and fourth clutches and the second brake,
a sixth forward speed stage is achieved by operation of the first, second, and fourth clutches,
a seventh forward speed stage is achieved by operation of the first and fourth clutches and the first brake,
an eighth forward speed stage is achieved by operation of the first and third clutches and the first brake,
a ninth forward speed stage is achieved by operation of the second and third clutch and the first brake,
a reverse speed stage is achieved by operation of the first and fourth clutches and the second brake.

10. The planetary gear train of claim 7, wherein
a first forward speed stage is achieved by operation of the first and third clutches and the second brake,
a second forward speed stage is achieved by operation of the second and third clutches and the second brake,
a third forward speed stage is achieved by operation of the first clutch and second clutch and the second brake,
a fourth forward speed stage is achieved by operation of the second clutch and the first and second brakes,
a fifth forward speed stage is achieved by operation of the second and fourth clutches and the second brake,
a sixth forward speed stage is achieved by operation of the second and fourth clutches and the first brake,
a seventh forward speed stage is achieved by operation of the first, second, and fourth clutches,
an eighth forward speed stage is achieved by operation of the first and fourth clutches and the first brake,
a ninth forward speed stage is achieved by operation of the first and third clutch and the first brake,
a tenth forward speed stage is achieved by operation of the second and third clutches and the first brake,
a reverse speed stage is achieved by operation of the first and fourth clutches and the second brake.

11. The planetary gear train of claim 7, wherein
a first forward speed stage is achieved by operation of the first and third clutches and the second brake,
a second forward speed stage is achieved by operation of the second and third clutches and the second brake,
a third forward speed stage is achieved by operation of the first clutch and second clutch and the second brake,
a fourth forward speed stage is achieved by operation of the second clutches and the first and second brakes,
a fifth forward speed stage is achieved by operation of the second and fourth clutches and the second brake,
a sixth forward speed stage is achieved by operation of the second and fourth clutches and the first brake,
a seventh forward speed stage is achieved by operation of the first, second, and fourth clutches,
an eighth forward speed stage is achieved by operation of the first and fourth clutches and the first brake,
a ninth forward speed stage is achieved by operation of the third and fourth clutches and the first brake,
a tenth forward speed stage is achieved by operation of the first and third clutches and the first brake,
an eleventh forward speed stage is achieved by operation of the second and third clutches and the first brake,
a reverse speed stage is achieved by operation of the first and fourth clutches and the second brake.

12. A planetary gear train of an automatic transmission for a vehicle, comprising:
an input shaft configured for receiving torque of an engine;
an output shaft configured for outputting changed torque;
a first planetary gear set that is a single-pinion planetary gear set and including a first sun gear, a first planet carrier, and a first ring gear;
a second planetary gear set that is a single-pinion planetary gear set and including a second sun gear, a second planet carrier, and a second ring gear;
a third planetary gear set that is a single-pinion planetary gear set, and including a third sun gear, a third planet carrier, and a third ring gear;
a first rotation shaft including the first sun gear and selectively connectable to a transmission housing;
a second rotation shaft including the first planet carrier and directly connected to the input shaft;
a third rotation shaft including the first ring gear and the third sun gear;
a fourth rotation shaft including the second sun gear and selectively connectable to the first rotation shaft and the second rotation shaft;
a fifth rotation shaft including the second planet carrier and selectively connectable to the third rotation shaft;
a sixth rotation shaft including the second ring gear and the third planet carrier and directly connected to the output shaft;
a seventh rotation shaft including the third ring gear, and selectively connectable to the fifth rotation shaft or selectively connectable to the transmission housing.

13. The planetary gear train of claim 12, further comprising:
a first clutch that selectively connects the second rotation shaft and the fourth rotation shaft;
a second clutch that selectively connects the first rotation shaft and the fourth rotation shaft;
a third clutch that selectively connects the third rotation shaft and the fifth rotation shaft;
a fourth clutch that selectively connects the fifth rotation shaft and the seventh rotation shaft;
a first brake that selectively connects the first rotation shaft and the transmission housing; and
a second brake that selectively connects the seventh rotation shaft and the transmission housing.

14. The planetary gear train of claim 13, wherein
a first forward speed stage is achieved by operation of the first and third clutches and the second brake,
a second forward speed stage is achieved by operation of the second and third clutches and the second brake,
a third forward speed stage is achieved by operation of the first clutch and second clutch and the second brake,
a fourth forward speed stage is achieved by operation of the second clutch and the first and second brakes,
a fifth forward speed stage is achieved by operation of the second and fourth clutches and the second brake,
a sixth forward speed stage is achieved by operation of the first, second, and fourth clutches,
a seventh forward speed stage is achieved by operation of the first and fourth clutches and the first brake,
an eighth forward speed stage is achieved by operation of the first and third clutches and the first brake,
a ninth forward speed stage is achieved by operation of the second and third clutch and the first brake,
a reverse speed stage is achieved by operation of the first and fourth clutches and the second brake.

15. The planetary gear train of claim 13, wherein
a first forward speed stage is achieved by operation of the first and third clutches and the second brake,
a second forward speed stage is achieved by operation of the second and third clutches and the second brake,
a third forward speed stage is achieved by operation of the first clutch and second clutch and the second brake,
a fourth forward speed stage is achieved by operation of the second clutch and the first and second brakes,
a fifth forward speed stage is achieved by operation of the second and fourth clutches and the second brake,
a sixth forward speed stage is achieved by operation of the second and fourth clutches and the first brake,
a seventh forward speed stage is achieved by operation of the first, second, and fourth clutches,
an eighth forward speed stage is achieved by operation of the first and fourth clutches and the first brake,
a ninth forward speed stage is achieved by operation of the first and third clutch and the first brake,
a tenth forward speed stage is achieved by operation of the second and third clutches and the first brake,
a reverse speed stage is achieved by operation of the first and fourth clutches and the second brake.

16. The planetary gear train of claim 13, wherein
a first forward speed stage is achieved by operation of the first and third clutches and the second brake,
a second forward speed stage is achieved by operation of the second and third clutches and the second brake,
a third forward speed stage is achieved by operation of the first clutch and second clutch and the second brake,
a fourth forward speed stage is achieved by operation of the second clutches and the first and second brakes,
a fifth forward speed stage is achieved by operation of the second and fourth clutches and the second brake,
a sixth forward speed stage is achieved by operation of the second and fourth clutches and the first brake,
a seventh forward speed stage is achieved by operation of the first, second, and fourth clutches,
an eighth forward speed stage is achieved by operation of the first and fourth clutches and the first brake,
a ninth forward speed stage is achieved by operation of the third and fourth clutches and the first brake,
a tenth forward speed stage is achieved by operation of the first and third clutches and the first brake,
an eleventh forward speed stage is achieved by operation of the second and third clutches and the first brake,
a reverse speed stage is achieved by operation of the first and fourth clutches and the second brake.
